(19) United States
(12) Patent Application Publication
(10) Pub. No.: US 2013/0038070 A1
(43) Pub. Date: Feb. 14, 2013

(54) METHOD FOR ASSEMBLING PART OF A GENERATOR, GENERATOR AND WIND TURBINE

(71) Applicant: Kurt Andersen, Vorbasse (DK)

(72) Inventor: Kurt Andersen, Vorbasse (DK)

(21) Appl. No.: 13/578,001

(22) PCT Filed: Feb. 16, 2010
(86) PCT No.: PCT/EP10/00961

§ 371 Date: Oct. 25, 2012

(51) Int. Cl. H02K 1/28; H02K 15/00; F03D 9/00

(52) U.S. Cl. 290/55; 310/216.136; 228/101

(57) ABSTRACT

A method for assembling part of a generator is disclosed. A magnet assembly with at least one magnet and a mounting plate is fastened to a base element by welding the mounting plate to the base element.

### CROSS REFERENCE TO RELATED APPLICATIONS

This application is the US National Stage of International Application No. PCT/EP2010/000961, filed Feb. 16, 2010 and claims the benefit thereof. All of the applications are incorporated by reference herein in their entirety.

### FIELD OF INVENTION

The present invention relates to a method for assembling part of a generator. It further relates to a generator and to a wind turbine.

### BACKGROUND OF INVENTION

Permanent magnet (PM) generator rotors for wind turbines are known in the art. Here rods or segments of permanent magnet material are mounted on the surface of a generator rotor on some rotor base construction. The purpose of the magnets is to induce current in generator stator coils which they pass when the generator rotor is rotating. It is of most importance that the magnets are sufficiently secured to the said rotor base construction as the distance between the magnets and the stator coils often is only a few millimetres.

In EP 1 860 755 A2 a permanent magnet rotor arrangement is provided. The arrangement includes a rotor having a radially outer rim. A circumferential array of magnet carriers is a fixed to the outer rim of the rotor by means of at least one screw or bolt. The bolts or screws penetrate the rotor base construction and are attached to a threaded portion of the mounting plate.

### SUMMARY OF INVENTION

One difficulty related to the former mentioned prior art is that the process of fitting or mounting the permanent magnets including their mounting plate to the rotor base is very time consuming because numerous bolts and nuts are required in order to hold and maintain the permanent magnet in the correct position and to withstand the magnetic attractive forces that act on the magnets once magnetized. The bolts have to be mounted and tightened manually.

A first objective of the present invention is to provide an advantageous method for assembling part of a generator. A second objective of the present invention is to provide an advantageous generator. A third objective of the present invention is to provide an advantageous wind turbine.

The first objective is solved by the method for assembling part of a generator. The second objective is solved by a generator. The third objective is solved by a wind turbine. The depending claims define further developments of the invention.

In the inventive method for assembling part of a generator a magnet assembly comprising at least one magnet and a mounting plating is fastened to a base element by welding the mounting plate to the base element. Using welding instead of bolts, nuts or screws has the advantage, that it is simple, effective and cost-effective. For example, bolts, nuts or screws have to be mounted and tightened manually, while the spot welding can be performed by means of an industrial robot.

The magnet assembly may be positioned and maintained in the position before welding it to the base element. The base element may be, for example, part of a rotor of the generator.

Preferably, a non-magnetized magnet may be used. The non-magnetized magnet can be magnetized after welding the mounting plate to the base element. Using a non-magnetized magnet is advantageous, because during the fastening process no attractive magnetic forces are acting between the magnet and the means for fastening.

Preferably, the mounting plate is welded to the base element by means of an industrial robot. Such industrial robot can perform multiple of the steps required for the mounting process. For example, the industrial robot may pick up a preinstalled magnet assembly from storage and may position it in a correct position on the generator base element. The base element may be, for example, a generator rotor base construction. Moreover, the industrial robot may maintain the position during fastening without the need of other holding means. Furthermore, the industrial robot can fasten the magnet assembly to the base element by welding the mounting plate to the base construction at a plurality of welding points, especially spot welding points, along the mounting plate construction.

Preferably, the mounting plate may be fastened to the base element by spot-welding the mounting plate to the base element. Braze-welding and/or hard-soldering is also possible.

As to the number of welding points it must be ensured that enough points are made so that the permanent magnet assembly will maintain its position both during mounting and during operation. The permanent magnet assembly has to be able to withstand any magnetic attractive forces that may occur once the magnet is magnetized.

Furthermore, by the present invention it is ensured that at least the process of fastening the permanent magnet assembly to the base construction is shortened in time as the time consuming process of tightening nuts to specific moment-level is replaced by a speedy industrial robot spot welding process.

The inventive generator comprises a magnet assembly and a base element. The magnet assembly comprises at least one magnet and a mounting plate. The mounting plate is fastened to the base element by means of a number of welds, preferably spot-welds. For example, the generator may comprise a rotor. The base element may be part of the rotor or the base element may be connected to the rotor.

The magnet assembly can comprise at least one permanent magnet. Moreover, the magnet can be segmented. This allows for an easy assembling. For example, a number of permanent magnets may be connected to the same mounting plate.

Advantageously, the magnet can be covered by a protective cover. The protective cover can comprise stainless steel or a plastic material. For example, the protective cover may consist of stainless steel or a plastic material. The protective cover provides a protection of the magnet or of the magnet material against corrosion and other environmental influences.

Generally, the generator may be a direct drive generator.

The mounting plate may be fastened to the base element by means of a number of spot-welds and/or braze-welds and/or hard-soldering.

The inventive wind turbine comprises an inventive generator, as previously described. The inventive wind turbine has the same advantages as the inventive generator has.

In the context of the present invention welding comprises spot-welding, braze-welding and soldering, especially hard-soldering.

### BRIEF DESCRIPTION OF THE DRAWINGS

Further features, properties and advantages of the present invention will become clear from the following description of an embodiment in conjunction with the accompanying drawings.

FIG. 1 schematically shows a wind turbine.

FIG. 2 schematically shows part of an inventive generator in a perspective view.

### DETAILED DESCRIPTION OF INVENTION

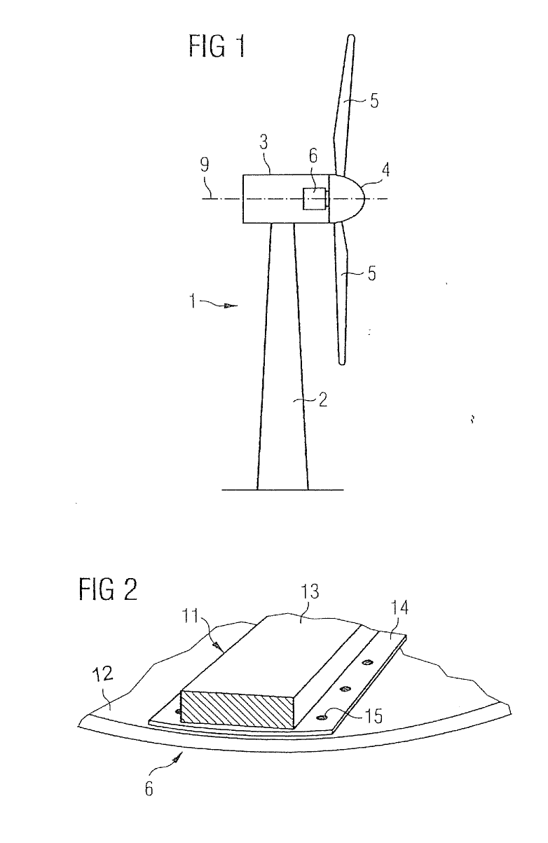

An embodiment of the present invention will now be described with reference to FIGS. 1 and 2.

FIG. 1 schematically shows a wind turbine 1. The wind turbine 1 comprises a tower 2, a nacelle 3 and a hub 4. The nacelle 3 is located on top of the tower 2. The hub 4 comprises a number of wind turbine blades 5. The hub 4 is mounted to the nacelle 3. Moreover, the hub 4 is pivot-mounted such that it is able to rotate about a rotation axis 9. A generator 6 is located inside the nacelle 3. The wind turbine 1 is a direct drive wind turbine.

FIG. 2 schematically shows part of an inventive generator 6 in a perspective view. The generator 6 comprises a magnet assembly 11 and a base element 12. The magnet assembly 11 comprises at least one magnet 13 and a mounting plate 14. The magnet 13 is connected to the mounting plate 14. For example, a permanent magnet 13 is glued onto the mounting plate 14. The mounting plate 14 is fastened to the base element 12 by spot-welding. The weld points are designated by reference numeral 15.

The magnet 13 can be a permanent magnet. Advantageously, a non-magnetized magnet 13 is used, which is magnetized after spot-welding the mounting plate 14 onto the base element 12. This avoids disturbing attractive magnetic forces between the elements. Moreover, the magnet 13 may be segmented. For example, a number of permanent magnets 13 may be glued onto one mounting plate 14.

The base element 12 may be part of the rotor of the generator 6 or it may be connected to the rotor of the generator 6.

Furthermore, the magnet 13 can be covered by a protective cover. The protective cover may comprise stainless steel or a plastic material. The protective cover provides a protection of the magnet material against corrosion and other environmental influences.

Instead of spot-welds also braze-welds or hard-soldering is possible.

In summary, the present invention provides a simple and cost-effective generator, especially for a wind turbine, and a simple and cost effective method for mounting of permanent magnet assemblies to a generator rotor base.

1-14. (canceled)

15. A method for assembling part of a generator, comprising:
providing a magnet assembly comprising a magnet and a mounting plate; and
welding the mounting plate to a base element thereby fastening the magnet assembly to the base element.

16. The method as claimed in claim 15,
wherein the magnet assembly is positioned and maintained in the position before welding it to the base element.

17. The method as claimed in claim 15,
wherein a non-magnetized magnet is used as the magnet; the method further comprising:
magnetizing the non-magnetized magnet after the welding the mounting plate to the base element.

18. The method as claimed in claim 15,
wherein the mounting plate is welded to the base element via an industrial robot.

19. The method as claimed in claim 15,
wherein the welding is a type selected from the group consisting of a spot-welding, braze-welding, hard-soldering, and combinations thereof.

20. A generator, comprising:
a magnet assembly, comprising:
a magnet, and
a mounting plate; and
a base element:
wherein the mounting plate is fastened to the base element by a plurality of welds.

21. The generator as claimed in claim 20
wherein the generator comprises a rotor and the base element is part of the rotor.

22. The generator as claimed in claim 20,
wherein the generator comprises a rotor and the base element is connected to the rotor.

23. The generator as claimed in claim 20,
wherein the magnet is a permanent magnet.

24. The generator as claimed in claim 20,
wherein the magnet is segmented.

25. The generator as claimed in claims 21,
wherein the magnet is covered by a protective cover.

26. The generator as claimed in claim 25,
wherein the protective cover comprises stainless steel or a plastic material.

27. The generator as claimed in claim 20,
wherein the generator is a direct drive generator.

28. The generator as claimed in claim 20,
wherein the mounting plate is fastened to the base element by means of a number of spot-welds and/or braze-welds and/or hard-soldering. A wind turbine comprising a generator as claimed in claim 20.
